(19) United States
(12) Patent Application Publication
(10) Pub. No.: US 2026/0346656 A1
(43) Pub. Date: Nov. 5, 2026

(54) RUN-FLAT INSERT FOR A VEHICLE WHEEL ASSEMBLY

(71) Applicants: Abraham Pannikottu, Akron, OH (US); Jon Stuart Gerhardt, Charlotte, NC (US); Robert James Snyder, Fairlawn, OH (US)

(72) Inventors: Abraham Pannikottu, Akron, OH (US); Jon Stuart Gerhardt, Charlotte, NC (US); Robert James Snyder, Fairlawn, OH (US)

(21) Appl. No.: 19/195,951

(22) Filed: May 1, 2025

(51) Int. Cl. B60C 17/04

(52) U.S. Cl. CPC B60C 17/04; B60C 17/041

(57) ABSTRACT

A run-flat tire assembly includes a pneumatic tire having a wheel rim extending into the tire cavity through a first opening and an annular insert received by the wheel rim within the cavity. A rim assembly cap secured to the wheel rim at the opposite tire opening sealingly engages the beads of the pneumatic tire with wheel rim flanges. The annular insert is compressively mounted to the wheel rim and extends between 70%-90% of the height of the tire sidewalls such that, in a run-flat situation, the annular insert engages the interior of the deflated tire at the ground contact footprint, allowing the deflated tire to remain mounted on the wheel rim and continue in operation for a predetermined period of time and distance. The insert is readily mounted to the wheel rim within the tire cavity due to the fabrication of the insert from a plurality of identical arced sections that can be placed within the tire cavity and secured together therein.

### STATEMENT REGARDING FEDERALLY SPONSORED RESEARCH OR DEVELOPMENT

This invention was made with government support under Cooperative Agreement Award Nos. HQ0034-20-2-0007 and HQ0034-24-2-0001 awarded by the U.S. Department of Defense. The government has certain rights in the invention.

### TECHNICAL FIELD

The invention herein resides in the art of wheel and tire assemblies. More particularly, the invention relates to pneumatic tire and wheel assemblies designed to support loads and continue to effectively operate even in the event of a significant or complete loss of air pressure within the tire. More particularly, the invention relates to the implementation of various inserts that can be positioned about a wheel rim and within the envelope of a pneumatic tire that can serve to secure the tire to the wheel and maintain operative integrity in the event of a significant loss of air pressure within the tire envelope.

### BACKGROUND OF THE INVENTION

Pneumatic tires are commonly used for a broad range of land vehicles. As known, a significant loss of air pressure in such tires often renders the tires unsuited for continued use until the cause of the air pressure loss has been corrected. Over a course of time, various approaches have been employed to allow pneumatic tires to continue to run following a loss of air pressure for at least a sufficient period of time to move the vehicle to a point where repairs can be made. The art has further developed to the point where continued operation of the vehicle may be enjoyed for a significant length of time/distance, but with some restraints on operational speeds, distances and the like.

A particular goal in the military vehicle industry has been to provide a tire and wheel assembly which will operate at a vehicle speed of 30 mph over a distance of 30 miles, following loss of tire pressure, and to do so without destruction of the tire or wheel. Numerous attempts to achieve this goal have been attempted, but generally fall short of the requirement for successful military operation. When a tire loses significant pressure, it typically flattens at the ground contact footprint, often breaking the seal between the tire bead and the rim of the wheel, allowing for a complete disengagement of the tire from the wheel and a destruction of not only the tire by the wheel rim, but destruction of the wheel itself. In general, the prior art has failed to provide a structure or other means for substantially replicating an inflated pneumatic tire when forced to operate in a run-flat condition, thereby allowing the wheel assembly to destroy the tire and the wheel itself at the flattened footprint of the tire in continued operation.

### DISCLOSURE OF INVENTION

In light of the foregoing, it is the primary aspect of the invention to provide a pneumatic vehicle wheel assembly having an insert mounted to the wheel and retained within the envelope of the tire, the insert substantially replacing the lost air within the tire, providing integrity to the tire precluding a substantially flat footprint and ensuring that the bead of the tire remains engaged with the wheel rim.

The foregoing and other aspects of the invention that will become apparent herein are achieved by a run-flat tire assembly, comprising: a pneumatic tire having a circumferential tread and sidewalls extending from said tread to a pair of axially opposed first and second openings to a tire cavity; a wheel rim extending into said cavity from said first opening; an annular insert having outer and inner circumferential surfaces received by said wheel rim within said cavity; and a rim assembly cap secured to said wheel rim at said second opening, said wheel rim and rim assembly cap being sealingly engaged with beads of said pneumatic tire.

Further aspects of the invention are achieved by a method of mounting a run-flat annular insert to a wheel rim within a cavity of a pneumatic tire, comprising: inserting the wheel rim through a first tire opening into the tire cavity; assembling a plurality of components of a run-flat annular insert upon and about said wheel rim within said cavity; and mounting a rim cap to said wheel rim through a second tire opening, inflating the tire and sealing beads of the tire against first and second wheel rim flanges.

### BRIEF DESCRIPTION OF THE DRAWINGS

For a complete understanding of the various aspects, structures, and operation of the invention, reference should be made to the following detailed description and accompanying drawings, wherein:

FIG. 1 is an assembly diagram of a first embodiment of the invention;

FIG. 2 is a front elevational view of a rubber/steel hoop insert employed in the embodiment of FIG. 1;

FIG. 3 is an assembly diagram of the rubber/steel hoop insert of FIG. 2;

FIG. 4 is an assembly diagram of a second embodiment of the invention;

FIG. 5 is a front elevational view of the three-piece carbon fiber insert of the embodiment of FIG. 4;

FIG. 6 is an assembly diagram of the insert of FIG. 5;

FIG. 7 is an assembly diagram of an embodiment of the invention employing a three-piece injection molded insert;

FIG. 8 is a front elevational view of the three-piece injection molded insert of FIG. 7;

FIG. 9 is an assembly diagram of the insert of FIG. 8;

FIG. 10 is an assembly diagram of an additional embodiment of the invention employing a four-piece injection molded insert;

FIG. 11 is a front elevational view of the insert employed in FIG. 10;

FIG. 12 is an assembly drawing of the insert of FIG. 11;

FIG. 13 is an assembly diagram of an embodiment of the invention employing a four-piece carbon fiber insert;

FIG. 14 is a front elevational view of the four-piece carbon fiber insert employed in FIG. 13;

FIG. 15 is a perspective view of a section of the four-piece carbon fiber insert of FIG. 14; and

FIG. 15 is a partial sectional view of a pneumatic tire mounted to a wheel assembly and receiving upon the wheel and within the envelope of the tire the four-piece carbon fiber insert of FIG. 14.

### DETAILED DESCRIPTION OF PREFERRED EMBODIMENTS

In general, the invention herein consists of an insert that is securely positioned inside a tire and firmly attached to the rim. It is composed of an annular ring formed by multiple arc-shaped or semi-circle segments that are spaced around the rim and connected at each end to an adjacent segment. The segments are interconnected by a clamping system that restricts relative pivotal movement between the segments, thus effecting a substantially rigid annular structure within the tire envelope about the wheel rim.

The insert features a reinforced core positioned between elastomeric layers on both the outer circumference and inner circumference when fully assembled. This design boosts run-flat performance by enhancing mileage, load capacity, and vehicle handling, while also reducing weight and improving shock absorption. The insert consists of an outer elastomeric tread band and an inner elastomeric band ensuring a slightly radially compressed annular insert that forms an interference fit with a secure bead-to-bead seal.

The reinforced core of the insert ring can have a hollow structure, I-beam configuration, or inverted U-shape, and the reinforcing core can be made from materials such as steel, aluminum, composites, carbon fiber, or titanium. The radius of the insert will be 70% to 90% of the height of tire sidewall. This segmented run-flat ring consists of two, three or four arc-shaped components, sandwiched with rubber or polyurethane.

A goal in the military vehicle industry has been to provide a tire and wheel assembly which will operate at a vehicle speed of 30 miles per hour over a distance of 30 miles following loss of tire pressure, and to do so without destruction of the tire or wheel. An insert hoop design with elastomer pads in both inner and outer circumferential areas, is mounted on the wheel rim and inside of the pneumatic tire such that, in case of loss of inflation pressure by the tire, the insert design is capable of taking up the vehicle loads and distribution of forces around the insert ring, particularly providing improved performance in load carrying and vehicle handling in zero pressure operation. The system includes one or more arc segments to form a circular insert. The arcs are easily aligned and connected to form a run-flat device suitable for installation at the center of wheel rim.

Additionally, the invention features one or more insert segments in arcs or semi-circles made from a strong or rigid structure, along with one or more outer and inside layers made from a softer or lower durometer material. In one aspect, the outer and inside elastomer segment(s) are molded around or directly bonded onto the encapsulated rigid segment(s).

An elastomer about the inner circumference of the insert, with more flexibility and resilience than that about the outer circumference allows the insert to conform to the shape and surface of the rim with substantial grip.

An insert with an arch shaped internal contact surface with the wheel rim inner surface, provides an elastomer bead lock edge with significant lateral bead locking force. This prevents the tire from coming loose from the rim under stress or deformation. The enhanced locking force ensures the system is designed to hold the tire securely to the rim even without the internal pressure that normally helps keep it in place in traditional pneumatic tires.

A radial arch distributes radial forces more evenly to upper parts of the insert and provides structural support with low stiffness. Elastomer at the inside circumference of the insert provides a bead lock edge that enhances the bead locking force in airless mode.

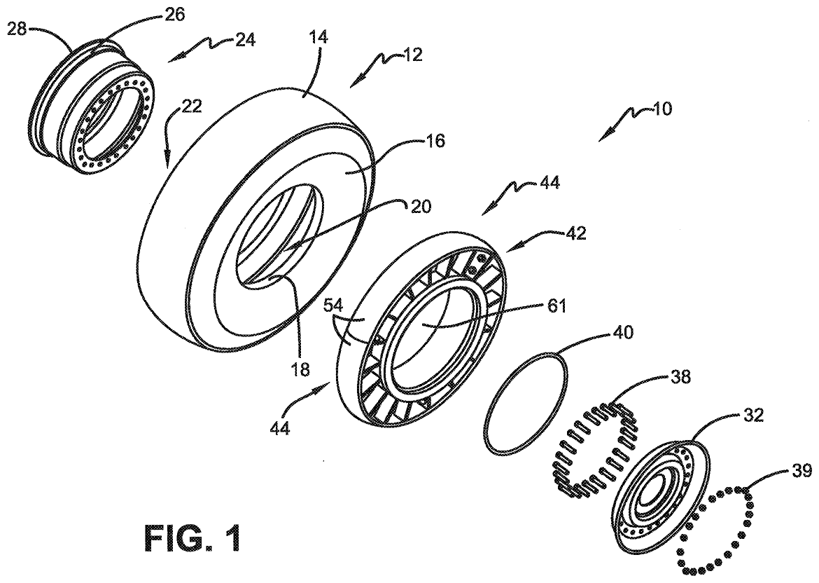

Referring now to the drawings and more particularly FIGS. 1-3, it can be seen that a run-flat tire assembly according to the invention is designated generally by the numeral 10. The assembly 10 includes a pneumatic tire 12 of cured rubber and having a tread 14 about the outer circumferential surface thereof. Sidewalls 16 extend from the tread 14 to tire beads 18 surrounding and defining an annular opening 20 on each side of the tire 12. The openings 20 access a cavity 22. A rim assembly 24, having a cylindrical body 26 and a first flange 28 adapted to seat a first one of the tire beads 18 characterize the rim assembly in standard fashion. The end 30 of the rim assembly 24 is characterized by a plurality of uniformly spaced bores 31 on an annular end of the cylindrical body 26. The bores 31 may be threaded or unthreaded, depending upon the locking mechanism for securing the rim assembly cap 32 to the rim assembly 24.

The rim assembly cap 32 includes a second flange 34, adapted for seating with a second of the tire beads 18. The rim assembly cap is also characterized by bores 36, which may or may not be threaded bores, again depending upon the method of securement of the rim assembly cap 32 to the rim assembly 24. In that regard, lock bolts 38a and lock nuts 39 may be included for the attachment of the rim assembly cap 32 to the rim assembly 24.

An o-ring seal 40 is provided for ensuring sealed interconnection between the rim assembly cap 32 and rim assembly 24. As shown in FIG. 1, a rubber/steel hoop insert 42 comprised of three interconnected sections 44 form the three-piece insert 42.

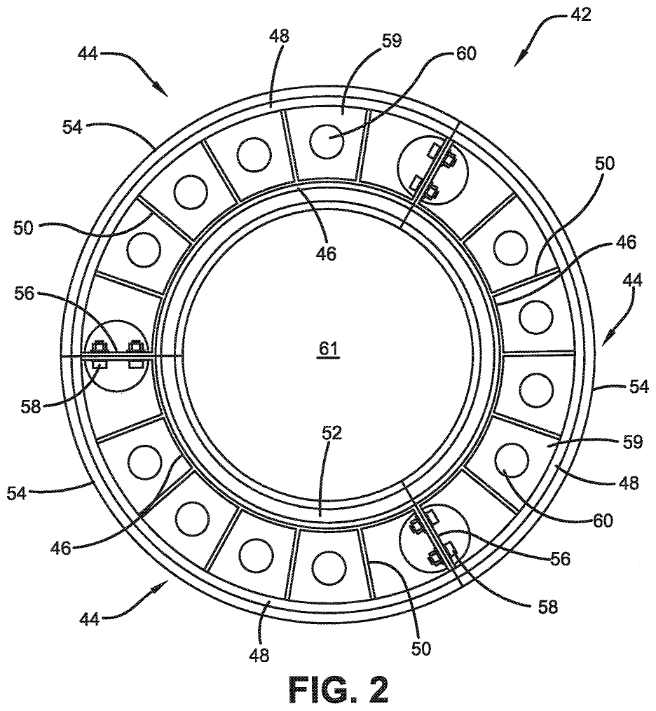

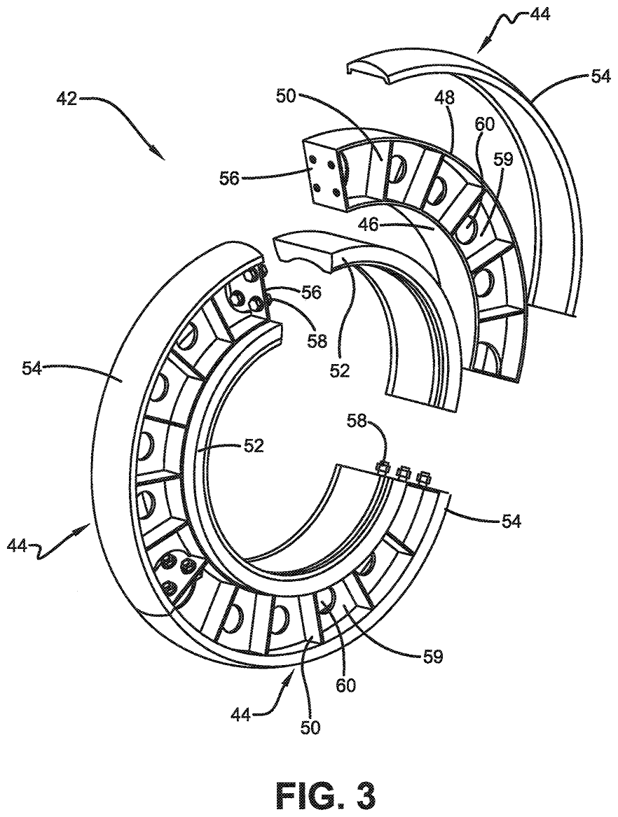

As best shown in FIGS. 2 and 3, the sections 44 each comprise an inner metallic ring section 46, outer metallic ring section 48, and steel webs extending radially in interconnection therebetween. Each of the sections 44 includes an inner layer of soft rubber or polyurethane 52 and an outer layer of harder rubber 54. The rubber 52 is on the order of Shore A 60 durometer rubber. Each end of the sections 44 are characterized by metal end plates 56 to allow secure interconnection between these sections 44 by nut and bolt assemblies 58.

Weight reduction may be obtained by the presence of apertures 60 in arcuate plates 59 interconnecting adjacent steel webs 50.

As can be seen, the resulting structure of the rubber/steel hoop insert 42 is a beam configuration with outside members 48 and inner members 46 interconnected by the steel webs 50, further interconnected by arcuate plates 59 with aperture 60.

Preferably, each of the sections 44 is identical to the other two, and each account for 120° of the annular hoop insert 42.

The aperture 61 of the rubber/steel hoop insert 42 is adapted for secured engagement upon the rim assembly 24 as each of the sections 44 is assembled with the other sectors upon the cylindrical body 26 of the rim assembly 24. Such assembly takes place within the cavity 22 of the tire 12. The inner layer of soft rubber 52 grips the cylindrical body 26 as the nut and bolt assemblies 58 secure the end plates 56, completing the annular insert 42.

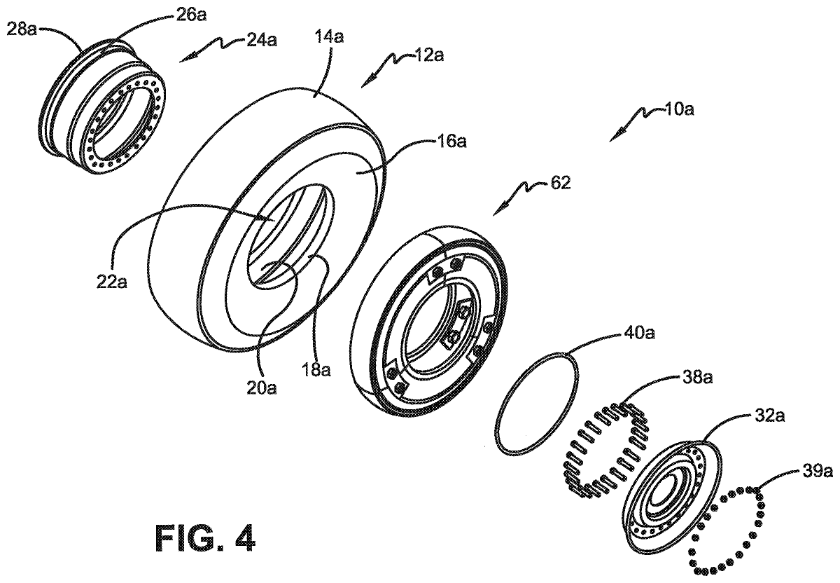

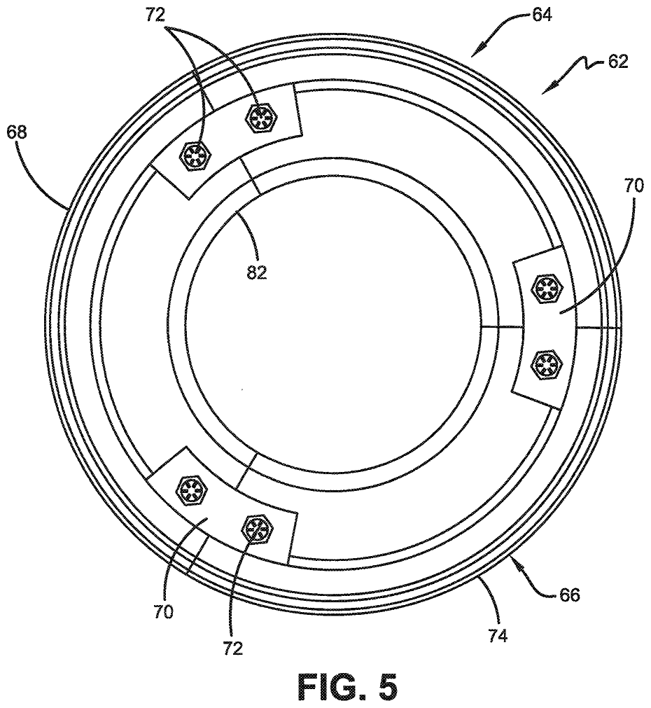

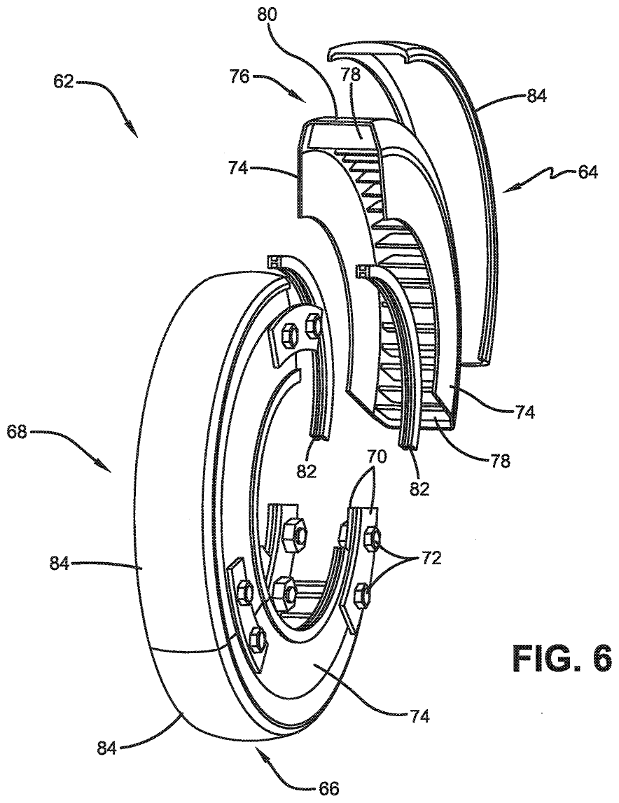

With reference now to FIGS. 4-6, a second embodiment of the invention is shown with the designation 10a as employing a three-piece carbon fiber insert. Within FIGS. 4-6, elements common to the embodiment of FIGS. 1-3 are designated with the same numerals, followed by the suffix “a.” In the embodiment of 10a, the hoop insert 62 is of a long carbon fiber construction formed from a plurality of substantially identical arc shaped segments 64, 66, 68, each formed by compression molding and constituting 120° of the annular hoop insert 10a.

Plates 70 are positioned on opposite sides of the joinder of adjacent segments 64, 66, 68 and are secured by nut and bolt assemblies 72 passing between and securing the plates, as shown. Each of the segments 64, 66, 68 has a pair of side walls 74 extending to form a u-shaped channel segment 76 of long carbon fiber construction. Such channels are lightweight and easy to manufacture. The u-shaped channel provides an I-beam configuration for strength and rigidity. Circumferentially spaced apart are a plurality of radially extending vanes 78 interconnecting between the side walls 74 and the channel cap 80. Again, each of the arc shaped segments 66-70 has a soft rubber ring segment 82 capping the inner circumferential surfaces of the side walls 74. This soft rubber or polyurethane provides for cushioning and gripping engagement between the hoop insert 62 and the cylindrical body 26a of the rim assembly 24a, to which it will be mounted. Similarly, each of the arc shaped segments 64-68 has a tread cap segment 84 of harder rubber or the like fixed to the channel cap 80.

As with the embodiment of FIGS. 1-3, the assembly of the long carbon fiber compression molded insert 62 takes place upon and about the rim assembly 24a within the cavity 22a. The segments 64, 66, 68 are sufficiently sized to be placed within the cavity 22 and over the cylindrical body 26a of the rim assembly 24a and mounted thereto with the soft rubber ring segments 82, completing an entire ring, being compressively and securedly mounted to and in engagement with the rim assembly 24a. As with the various embodiments herein, the result is a rim assembly having hoop insert securedly mounted thereto and substantially integral therewith maintained within the cavity or envelope 22a of the tire 12a and providing sufficient strength to engage with the inner surface of the tire 12a in an extremely low pressure or run-flat condition that the operability of the tire and wheel assembly continues and that the bead and flange interconnections between the tire and the hub assembly do not fail.

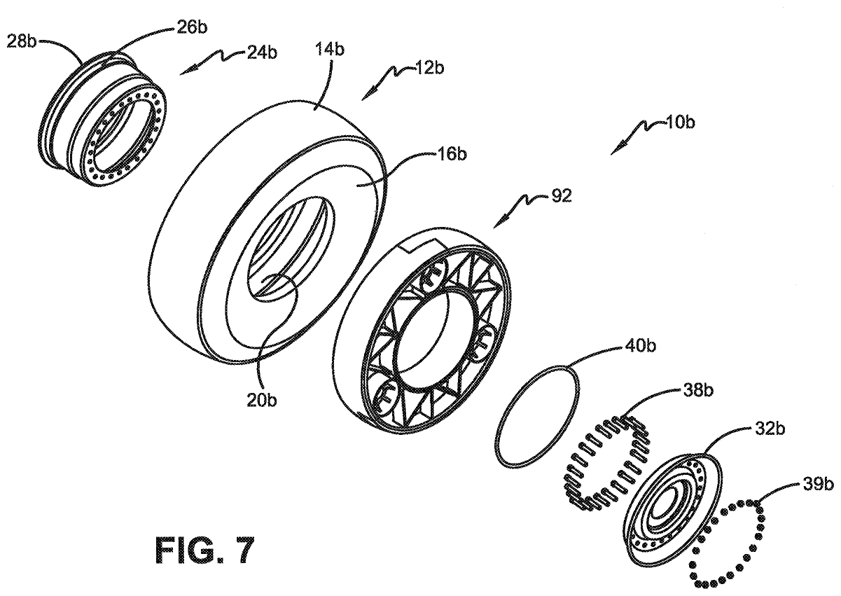

With reference now to FIGS. 7-9, a third embodiment of the invention can be seen as designated by the numeral 10b. As before, structures common with other embodiments herein are designated by the same numerals, but with the added suffix “b.”

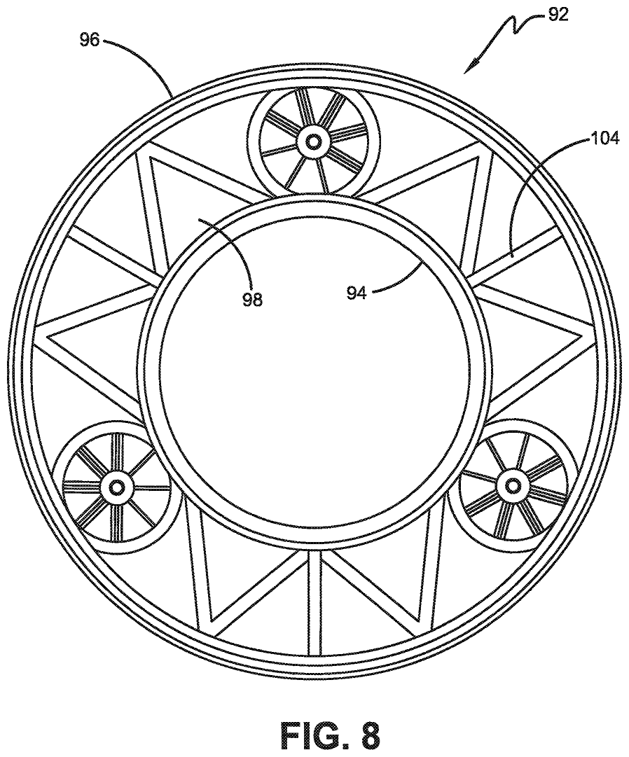

In the embodiment of FIGS. 7-9, a three-piece injection molded hoop insert 92 is employed. As shown in FIG. 8, the injection molded hoop insert 92 has an inside circumference covered with soft rubber or polyurethane as previously described. The outside circumference 96 is covered with a tread layer of harder rubber.

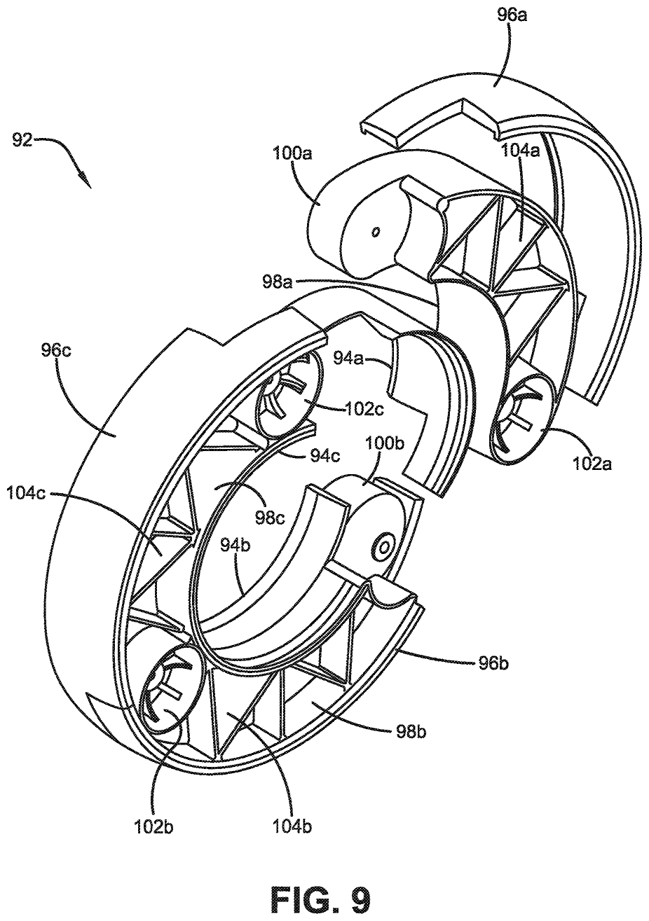

As shown in FIGS. 8 and 9, an annular body 98 is formed of three distinct arcuate sections 98a, 98b, 98c of polyurethane or engineered plastic to accommodate injection molding. Each of the arcuate sections 98a, 98b, 98c has a respective first end 100a, 100b, 100c specifically adapted for nesting with an end 102a, 102b, 102c of the next adjacent arcuate section forming the annular body 98. These nesting sections are interconnected by appropriate nut and bolt connection or the like. As further illustrated, each of the arcuate sections 98 has an associated truss structure 104a, 104b, 104c to provide a continuing truss structure when the annular body is formed by interconnection of the three arcuate sections by appropriate nut and bolt interconnection.

It will be appreciated that the hoop insert 92 comprises three sections that are sized to be interconnected upon the rim assembly 24 within the wheel cavity or envelope 92. The assembly process clamps the hoop insert 92 upon the rim assembly 24 with a slight compression of the soft rubber ring of the inside circumference 94. It will also be appreciated from FIG. 9 that the arcuate sections 98a, 98b, 98c of the annular body 98, the inside covering of soft rubber 94 by sections 94a, 94b, 94c, and the outside circumferential covering with a tread of harder rubber by sections 96a, 96b, 96c are effected with interchangeable sections. When assembled, these sections preclude a straight axial line of interconnection that traverses the width of the insert 92. This provides for an extremely durable insert that is not given to fatigue, cracking, or separation. The outside rubber tread layer 96 provides a slight cushioning effect when contacting the inner footprint of the tire in a run-flat mode, while the continuing truss established by the sections 104a, 104b, 104c provides a continuum of strength and rigidity.

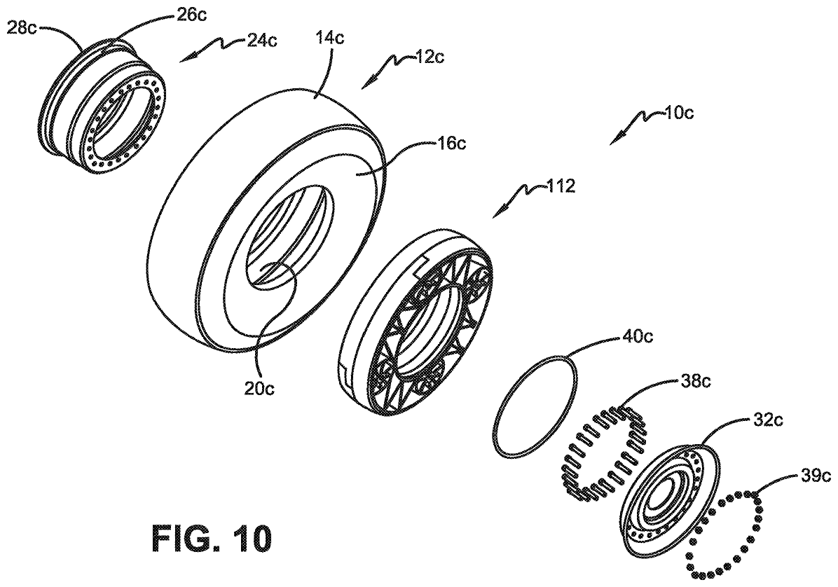

Referring now to FIGS. 10-12, it can be seen that a fourth embodiment of the invention is designated generally by the numeral 10c. As above, common elements with the prior embodiments are designated with the same numerals, but with the accompanying suffix “c.” Here, the invention contemplates a four-piece injection molded insert assembly 112, having an inside circumference 114 covered with a soft rubber or polyurethane for effecting gripping securement with the rim assembly 24 when assembled thereupon within the cavity or envelope 22c. As can be seen, an outside circumference of the insert 112 is covered with a hard rubber 112, 116, as previously discussed. A truss 118 is also provided for strength and rigidity. It is presently contemplated that the body of the insert 112 is again injection molded from a suitable material such as polyurethane or suitable engineered plastic.

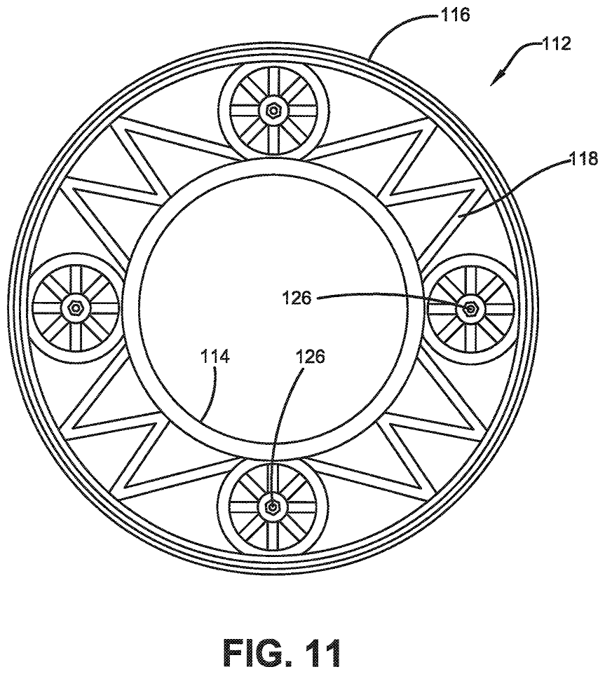

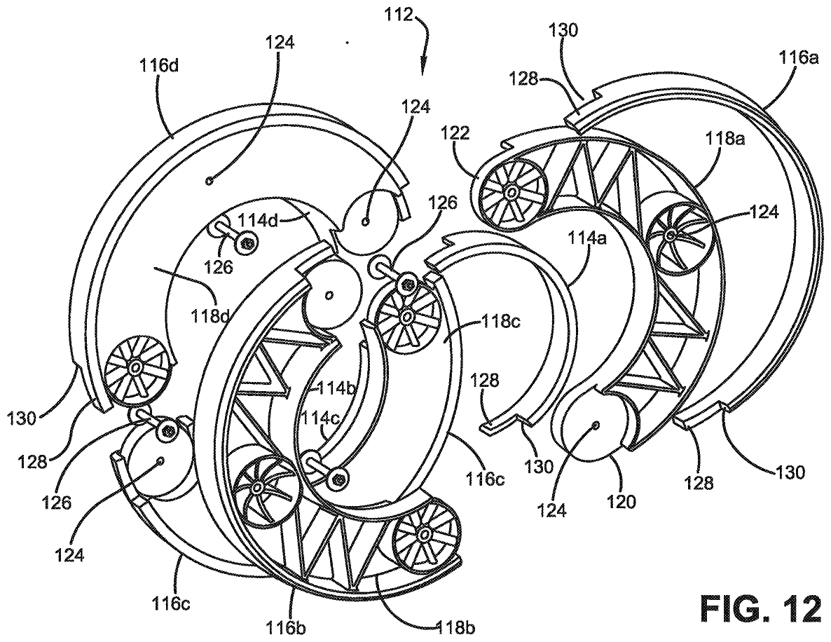

With particular reference to FIG. 12, it can be seen that the embodiment 112 consists of four substantially identical truss sectors 118a, 118b, 118c, 118d, each providing a 180° arc. Each of the truss sectors 118 receives an associated inner circumference sector 114 and outside circumference sector 116, each having an associated tab 128 and notch 130. Accordingly, there are four sectors to be interconnected upon the rim assembly 24 within the tire cavity 22. That interconnection is achieved by the forming of two complete rings from each of two sets of sectors and then axially joining those rings into a unitary unit as shown in FIGS. 10 and 11. This is effected by joining the nesting end connection pieces 120, 122 of two sets of paired sectors 118a, 118b, and 118c, 118d. These rings may then be joined axially by nut and bolt assemblies 126 axially interconnecting the ring assemblies through apertures 124.

With the assembly just described, it will again be appreciated that the injection molded insert 112 is formed of four identical truss sectors axially interconnected by four nut and bolt assemblies, and configured such that no interconnection of the four pieces axially traverses the entirety of the width of the insert, but rather extends only half of the width of the insert, and such regions of traverse are offset from each other by 90°. Accordingly, the injection molded four-piece insert 112 is provided with a continual side wall truss, a gripping soft rubber inside circumference, a rubber tread on the outside circumference, and which may be readily constructed and mounted to a wheel rim assembly within the cavity of a tire.

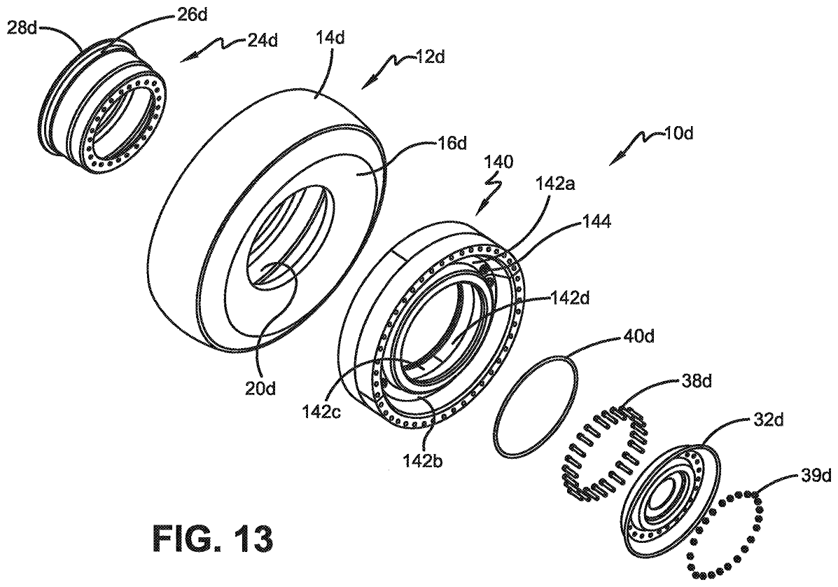

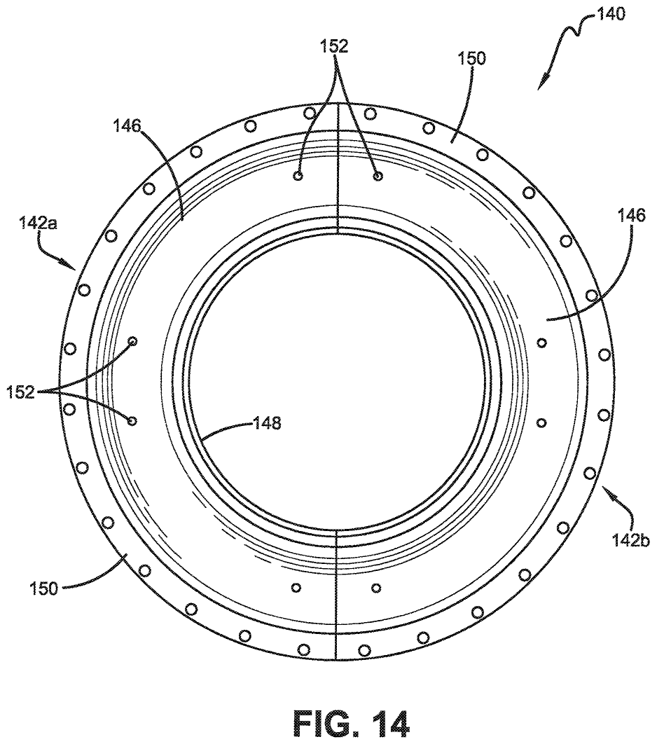

With reference now to FIGS. 13 and 14, it can be seen that another embodiment of a run-flat tire assembly, according to the invention, is designated generally by the label 10d. Again, where elements are common with prior embodiments, the elements are identified with the same numerical designation, accompanied by the suffix “d.” The embodiment 10d employs an insert 140 that is a four-piece carbon fiber insert consisting of four truss sections 142, each forming a semi-circle of 180° each, and designated 142a, 142b, 142c and 142d. Bridging brackets and bolt assemblies 144 secure the sectors 142 together, both axially and radially.

As shown in FIG. 14, each of the sections 142 comprises a carbon fiber beam 146 having an inner layer of soft sealing rubber 148 for engagement with the wheel rim, and an outer layer of harder rubber tread 150 for engaging the interior of the tire tread area under the run-flat condition. As shown in FIG. 14, pairs of holes 152 are provided for receiving the bridging bracket and bolt assemblies 144. Truss sections 142a and 142b abut each other and are connected on one side of the insert 140, while sections 142c and 142d abut each other and are connected on the opposite side of the insert 140. The two assemblies 142a, 142b and 142c, 142d are rotated 90° with respect to each other, such that each bridging bracket and bolt assembly 144 bridges and interconnects a pair of truss sections 142 on one side of the insert 140 and one side of a single section 142 at the center thereof on the other side. Pairs of holes 152 are provided in the carbon fiber beam 146 for receiving the bridging bracket and bolt assemblies 144.

As with other embodiments presented herein, the interconnections of the truss sections 142 ensure that there is no transverse line of connection or joint that crosses the entire width of fiber insert 140, ensuring strength, rigidity, and long life.

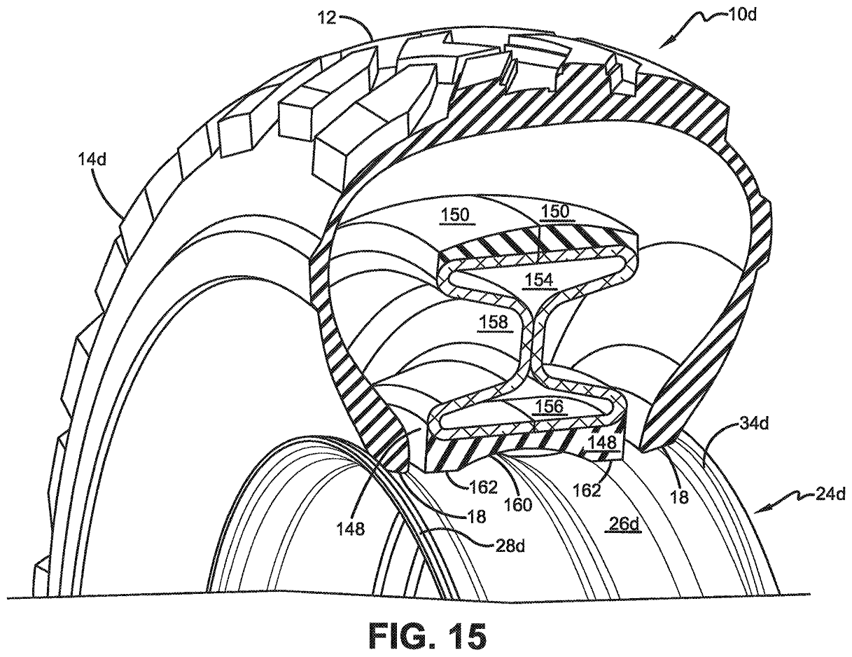

With reference now to FIG. 15, an appreciation of the structure and utility of the four-piece carbon fiber insert 140 within the cavity of a pneumatic tire 12 can be appreciated. As shown, the carbon fiber beam 146 has the general structure of an I-beam, having an outer flange 154, inner flange 156, and a connecting web 158. As noted, the inner layer of soft sealing rubber 148 engages the cylindrical body 26d of the rim assembly 24d and urges against the beads 18 of the tire 12 that are in sealed engagement with the first and second flanges 28d, 34d, as shown. The inner layer of soft sealing rubber 148 is characterized by an arch or concave recess 160 between two circumferential feet 162 that engage the cylindrical body 26d of the rim assembly 24d.

In the event of a run-flat situation, at the footprint of the tire upon the ground, the inner surface of the tire tread 14d urges against the outer layer of hard rubber tread 150 which, through the I-beam construction 146, imparts a compressive force against the inner layer of soft sealing rubber 148 applying a collapsing force against the arch 160 which urges the feet 162 outwardly against the beads 18, urging them into further sealing engagement with the flanges 28d, 34d, ensuring that the tire 12 remains upon the rim assembly 24d. This structure and operation significantly ensures that neither the tire 12 nor the rim assembly 24d is destroyed by the run-flat event and that the wheel and tire can continue to the desired time and distance.

It can be seen that the various aspects of the invention have been achieved by the structures, embodiments and operations presented above. While in accordance with the patent statutes only the best known and preferred embodiments of the invention have been presented and described in detail, the invention is not limited thereto or thereby. Accordingly, for an appreciation of the true scope of the invention, reference should be had to the following claims.

1. A run-flat tire assembly, comprising:
a pneumatic tire having a circumferential tread and sidewalls extending from said tread to a pair of axially opposed first and second openings to a tire cavity;
a wheel rim extending into said cavity from said first opening;
an annular insert having outer and inner circumferential surfaces received by said wheel rim within said cavity; and
a rim assembly cap secured to said wheel rim at said second opening, said wheel rim and rim assembly cap being sealingly engaged with beads of said pneumatic tire.

2. The run-flat tire assembly according to claim 1, wherein said inner circumferential surface of said annular insert is securely mounted to said wheel rim by a compressive layer of material about said inner circumferential surface.

3. The run-flat tire assembly according to claim 2, wherein said annular insert extends within said cavity to 70%-90% of a height of said sidewalls.

4. The run-flat tire assembly according to claim 3, wherein said annular insert is comprised of multiple interconnected arcuate sections.

5. The run-flat tire assembly according to claim 4, wherein said arcuate sections are interchangeable.

6. The run-flat tire assembly according to claim 5, wherein said arcuate sections are taken from the group of 120° and 180° arcuate sections.

7. The run-flat tire assembly according to claim 6, wherein said arcuate sections are of a construction taken from the group of beam, channel, and truss construction.

8. The run-flat tire assembly according to claim 7, wherein said arcuate sections are of a construction taken from the group of metal, carbon fiber and polyurethane.

9. The run-flat tire assembly according to claim 8, wherein said compressive layer has a surface in circumferential contact with said wheel rim securing said annular insert to said wheel rim.

10. The run-flat tire assembly according to claim 9, wherein said compressive layer is characterized by a concave arch separating said compressive layer from said wheel rim and accommodating axial expansion of said compressive layer outwardly against said beads, ensuring engagement between said beads and wheel flanges in a run-flat condition.

11. A method of mounting a run-flat annular insert to a wheel rim within a cavity of a pneumatic tire, comprising:
inserting the wheel rim through a first tire opening into the tire cavity;
assembling a plurality of components of a run-flat annular insert upon and about said wheel rim within said cavity; and
mounting a rim cap to said wheel rim through a second tire opening, inflating the tire and sealing beads of the tire against first and second wheel rim flanges.

12. The method of mounting a run-flat annular insert to a wheel rim according to claim 11, wherein said components are identical.

13. The method of mounting a run-flat annular insert to a wheel rim according to claim 12, wherein the step of assembling a plurality of components compressively engages said annular insert with said wheel rim.

14. The method of mounting a run-flat annular insert to a wheel rim according to claim 13, wherein said step that compressively engages said annular insert with said wheel rim leaves a concave arch between a portion of said annular insert and said rim.

15. The method of mounting a run-flat annular insert to a wheel rim according to claim 14, wherein said concave arch effects axial forceful engagement between said annular insert and said beads, enhancing sealing of the tire beads against the wheel rim flanges.
